(19) United States
(12) Patent Application Publication
(10) Pub. No.: US 2006/0076250 A1
(43) Pub. Date: Apr. 13, 2006

(54) Apparatus for containment of a dental brace

(76) Inventor: Daniel Kwasney, Port Charlotte, FL (US)

Correspondence Address: JAMES RAY & ASSOCIATES, 2640 Pitcairn Road, Monroeville, PA, 15146, US

(21) Appl. No.: 11/248,859

(22) Filed: Oct. 12, 2005

Related U.S. Application Data
(60) Provisional application No. 60/617,429, filed on Oct. 12, 2004.

(51) Int. Cl. A61C 19/10; A45F 5/00

(52) U.S. Cl. 206/83; 224/600; 224/269

(57) ABSTRACT

An apparatus for containment of a dental brace when the dental brace is removed from a user's mouth. The apparatus comprises a first mechanism for holding the dental brace. A second mechanism is attached to the first mechanism for safely securing the first mechanism to the user. The apparatus will hold a dental brace in a safe and sanitary method, thus reducing the chance of bacterial contamination and loss of the dental brace.

### CROSS-REFERENCE TO RELATED APPLICATIONS

This application is related to and claims priority from U.S. Provisional Patent Application Ser. No. 60/617,429 filed Oct. 12, 2004.

### FIELD OF THE INVENTION

The present invention generally relates to an apparatus for a dental brace, and more particularly, to an apparatus for containment of a dental brace.

### BACKGROUND OF THE INVENTION

Prior to the present invention, orthodontic dental braces are expensive and relatively fragile items, which are prone to bacterial contamination when the brace is removed from the user's mouth. Children, who are the most common users of dental braces, tend to be careless with the brace after it is removed from the mouth. When the dental brace is removed from the child's mouth during periods of eating, it is typically laid on the table. The dental brace is subject to bacterial contamination from the table, can be forgotten and lost, or accidentally thrown away when the child disposes of mealtime trash and debris. Additionally, the child may be subject to ridicule by other children who observe the dental brace sitting in full view on the table.

### SUMMARY OF THE INVENTION

In a first aspect, the present invention provides an apparatus for containment of a dental brace when such dental brace is removed from a user's mouth. The apparatus comprises a first means for holding the dental brace. A second means is attached to the first means for safely securing the first means to the user, whereby the apparatus will hold the dental brace in a safe and sanitary method, thus reducing the chance of bacterial contamination and loss of the dental brace.

### OBJECTS OF THE INVENTION

It is therefore the primary object of the present invention to provide an apparatus for containing a dental brace when the dental brace is removed from the user's mouth.

Another object of the present invention is to provide an apparatus for safely holding the dental brace when it is temporarily removed from the user's mouth.

Another object of the present invention is to provide an apparatus for storing the dental brace in a sanitary environment when the dental brace is temporarily removed from the user's mouth.

Another object of the present invention is to provide an apparatus that has aesthetic appeal when the user wears the apparatus.

In addition to the various objects of the invention that have been described above, various other objects and advantages of the invention will become readily apparent to those persons skilled in the relevant art from the following more detailed description of the invention, particularly, when such description is taken in conjunction with the attached drawing figures and appended claims.

### BRIEF DESCRIPTION OF THE DRAWINGS

FIG. 1 is an isometric view of the apparatus for containment of a dental brace;

FIG. 2 is a section view taken along line II-II of FIG. 1;

FIGS. 3, 4, and 5 are views of alternative embodiments of the apparatus for containment of a dental brace; and

FIG. 6 is plan view of the presently preferred embodiment of the apparatus for containment of a dental brace.

### BRIEF DESCRIPTION OF A PRESENTLY PREFERRED AND VARIOUS ALTERNATIVE EMBODIMENTS OF THE PRESENT INVENTION

Prior to proceeding to a more detailed description of the invention, it should be noted that identical components having identical functions have been designated with identical reference numbers for the sake of clarity.

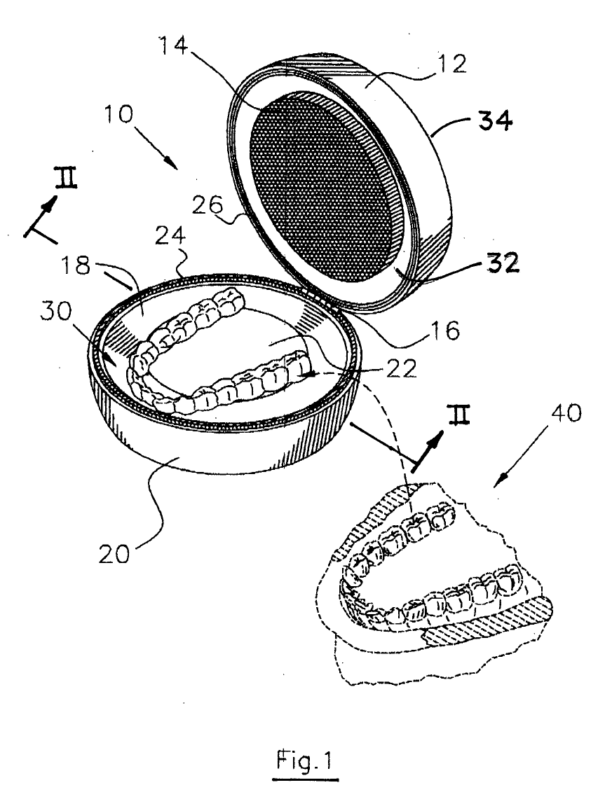

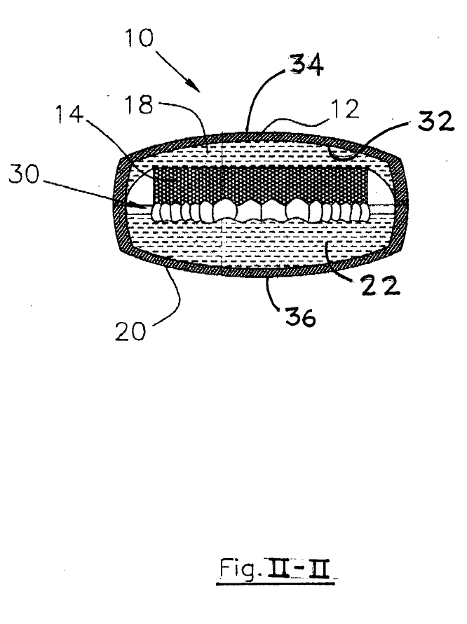

Now refer more particularly to FIGS. 1 and 2 of the drawings. Illustrated therein is an apparatus, generally designated 10, for containment of a dental brace 30 when removed from a user's mouth, generally designated 40. The apparatus comprises a first means generally designated 12 and 20 for holding a dental brace 30. The preferred first means 12 and 20 is a receptacle of a predetermined size, shape, and material. The present preferred shape is a cylindrical receptacle having a bottom portion 20 and a top portion 12. Preferably, the top portion 12 is attached to the bottom portion 20 by a hinge 16, wherein the hinge 16 further includes a spring preloaded in a closed position to allow the top portion 12 to maintain the closed position. It is presently preferred that the bottom portion 20 has a lip 24 that is engageable with a groove 26 in the top portion 12. This will tightly seal the apparatus 10 and further serve to protect the dental brace 30 from environmental contaminants. An alternative preferable embodiment is the top portion 12 attached to the bottom portion 20 by friction. Preferably, the top portion 12 is a lid having an interior surface 32 and an exterior surface 34. The present preferred interior surface 32 of the top portion 12 contains a removable sponge 14 of a preselected material on which a sterilization medium can be applied. The bottom portion 20 has an inner space 18 and an exterior surface 36. Preferably, the inner space 18 contains a removable, deformable medium 22 for securing and preventing movement of the dental brace 30 when it is stored in the apparatus 10. Preferably, the material of the apparatus 10 is at least one of metal and plastic. It is important that the present preferred material is easy to clean and sterilize. A second means generally designated 60 is attached to the first means 12 and 20 for safely securing the first means 12 and 20 to the user. Preferably, the second means 60 is at least one of a loop and neck chain, belt clip, bracelet, armband, and pin. The present preferred second means 60 is a loop and neck chain that can be worn safely and securely around the user's neck. The apparatus 10 will hold a dental brace 30 in a safe and sanitary method, thus reducing the chance of bacterial contamination and the accidental loss of the dental brace 30.

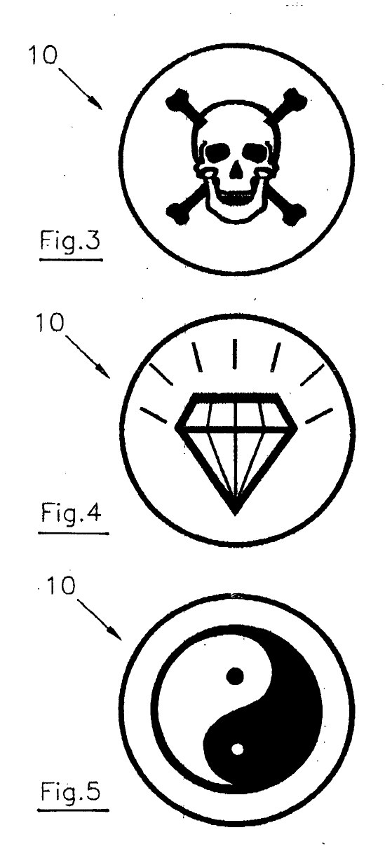

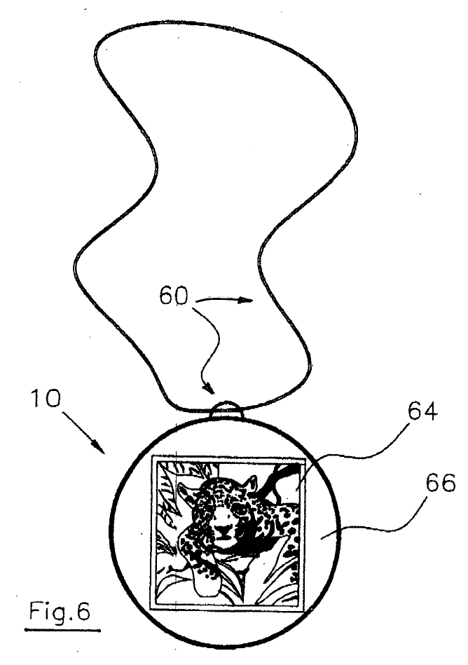

Now refer more particularly to FIGS. 3, 4, 5, and 6 of the drawings. Illustrated therein is an apparatus for containment of a dental brace 30, generally designated 10. Preferably, a transparent lens 66 is disposed on the exterior surface 34 of the top portion 12 of the apparatus 10. Preferably, a transparent lens 66 is also disposed on the exterior surface 36 of the bottom portion 20. A decorative image 64 can be selected by the user and inserted between the transparent lens 66 and the exterior surface 34 of the top portion 12. The image 64 can be a photograph, drawing, cartoon, logo, or any image that the user may choose. The images can be easily removed and exchanged, as the user desires.

Although the invention has been shown in connection with a certain specific embodiment, it will be readily apparent to those skilled in the art that various changes in form and arrangement of parts may be made to suit requirements without departing from the spirit and scope of the invention.

I claim:

1. An apparatus for containment of a dental brace when such dental brace is removed from a user's mouth, said apparatus comprising:
a) a first means for holding such dental brace; and
b) a second means attached to said first means for
safely securing said first means to such user, whereby said apparatus will hold such dental brace in a safe and sanitary method, thus reducing the chance of bacterial contamination and loss of such dental brace.

2. The apparatus according to claim 1 whereby said first means is a receptacle of a predetermined size, shape, and material.

3. The apparatus according to claim 2 whereby said receptacle has a bottom portion engageable with a top portion.

4. The apparatus according to claim 3 whereby said top portion is attached to said bottom portion by a hinge.

5. The apparatus according to claim 3 wherein said top portion is attached to said bottom portion by friction.

6. The apparatus according to claim 3 whereby said bottom portion contains a lip engageable with a groove in said top portion.

7. The apparatus according to claim 4 whereby said hinge further includes a spring preloaded in a closed position to allow said top portion to maintain such closed position.

8. The apparatus according to claim 3 whereby said top portion is a lid having an interior and exterior surface.

9. The apparatus according to claim 3 wherein said bottom portion has an inner space and an exterior surface.

10. The apparatus according to claim 8 whereby said interior of said lid contains a sponge of a preselected material on which a sterilization medium can be applied.

11. The apparatus according to claim 10 whereby said sponge is removable.

12. The apparatus according to claim 2 whereby said bottom portion contains a deformable medium of a preselected material for securing and preventing movement of such dental brace in said apparatus.

13. The apparatus according to claim 12 whereby said deformable medium is removable.

14. The apparatus according to claim 2 whereby said material is at least one of metal and plastic.

15. The apparatus according to claim 1 whereby said second means is at least one of a loop and neck chain, belt clip, bracelet, arm band, and pin.

16. The apparatus according to claim 15 whereby said second means is a loop and neck chain.

17. The apparatus according to claim 8 whereby a transparent lens is disposed on said exterior surface of said top portion for allowing an image to be inserted between said lens and said exterior surface of said top portion.

18. The apparatus according to claim 9 wherein a transparent lens is disposed on said exterior surface of said bottom portion for allowing an image to be inserted between said lens and said exterior surface of said bottom portion.

19. The apparatus according to claim 1 whereby said shape is generally cylindrical.
